(19) United States
(12) Patent Application Publication
(10) Pub. No.: US 2018/0157777 A1
(43) Pub. Date: Jun. 7, 2018

(54) PROGRAMMABLE PORTABLE EMULATOR FOR SENSING AND HARVESTING MATERIALS FOR CYCLIC HEAT ENERGY

(71) Applicants: Shuza Binzaid, San Antonio, TX (US); Wasim Hafiz Dipon, San Antonio, TX (US)

(72) Inventors: Shuza Binzaid, San Antonio, TX (US); Wasim Hafiz Dipon, San Antonio, TX (US)

(21) Appl. No.: 15/628,561

(22) Filed: Jun. 20, 2017

Related U.S. Application Data
(60) Provisional application No. 62/352,538, filed on Jun. 20, 2016.

(51) Int. Cl. G06F 17/50; G06F 17/13

(52) U.S. Cl. CPC G06F 17/5036; G06F 2217/16; G06F 17/13

(57) ABSTRACT

A novel design for programmable emulation of sensing and harvesting materials for cyclic energy conversion has been successfully implemented producing similar electrical characteristics over a wide-range of such materials. An in-depth study on this research had been done to construe those electrical properties of such materials including the voltage, current and signal frequencies before implementing the final emulator system. Parametric variations are fully programmable and user-friendly along with wide range of emulations made possible. The system is designed and implemented to be portable and ensured low power usage. Equivalent circuit was first designed and simulated to ensure proper functioning of the design. The equivalent circuit was then successfully implemented including the program codes embedded microcontroller. This novel design of the fully programmable emulator will bring vast advancement and accuracy in the emulations of these materials as single or clustered under various real-world conditions.

### CROSS-REFERENCE TO RELATED APPLICATIONS

This application claims the benefit under Title 35 United States Code § 119(e) of U.S. Provisional Patent Application Ser. No. 62/352,538; Filed: Jun. 20, 2016, the full disclosure of which is incorporated herein by reference.

### STATEMENT REGARDING FEDERALLY SPONSORED RESEARCH OR DEVELOPMENT

This invention was made with government support under 10000076 awarded by the National Science Foundation. The government has certain rights in the invention.

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to devices and methods for emulators. More specifically, the present invention relates to devices and methods comprising digital modules integrated to function as an emulator device/system utilizing program coding to operate mathematical formulation acting as a sensor and energy harvesting device.

### BACKGROUND OF THE INVENTION

Without limiting the scope of the disclosed devices and methods, the background is described in connection with a novel device and approach directed to a programmable portable emulator device for sensing and harvesting materials for cyclic heat energy.

Energy harvesting from alternate energy sources is now a prime area of interest for researchers that has turned into national priority of many countries. With technical advancements in the field of material science have increased the efficiency of the devices and advent of microcontroller technologies have made such applications more propounding. Using thermal energy to produce electricity have been a lucrative and attention grabbing concept which has led to extensive use of thermal energy harvesters all around the world. The coupled property between the thermal properties and the electrical properties of a material can be best represented by Heckmann diagram as shown in FIG. 1 The Heckmann diagram relates thermal, electrical and mechanical properties of a crystal [1].

The outer three corners represent the principal effects that are mechanical stress, electric field and temperature change. The corresponding dynamic properties of the material that are strain, dielectric displacement and entropy are shown in the three inner circles [2]. All these properties of materials are interrelated and can be explained using laws of thermodynamics. The following intensive and extensive variable pairs are most often used.

Thermal with Temperature and entropy

Mechanical with Elastic stress and strain

Electrical with Electric field and displacement

Pyroelectric effect is caused by alternating temperature change in cyclic fashion imposes non-destructive atomic displacement in the crystal lattice causing polarization in the material and thus resulting rise in potential difference of alternating electric field [3]. This process of alternating temperature change leading to subsequent processes is illustrated in FIG. 2 above for a temperature change of ΔT, represented by the side between electrical and thermal corners of the Heckmann diagram. The concept of pyroelectricity has been there from 314BC but with advancement of technology and advent of testing options there has been tremendous breakthrough for pyroelectric applications and testing. Right from simple uses as sensors and detectors the application footholds of pyroelectricity span into the sophisticated applications of implanted medical devices.

Presented herein is the development and implementation of a portable and fully programmable emulator device/system for pyroelectric materials which have uses as sensors and energy harvesters as well. The devised programmable digital emulator system can successfully emulate single module or clustered modules of pyroelectric materials over a range of 2 μA to 30 μA yielding a wide range of parametric emulations with significant accuracy. The device/system also provides a very user-friendly interface for programming and allows few hundreds of selections for emulation.

Advent of new technologies and applications of pyroelectric devices has made imperative to realistic and reliable testing setup. FIG. 3 shows a fully functional setup at room temperature suitable for pyroelectric material testing [4]. The existing testing platforms are expensive and sometimes require complicated setups that are extremely difficult and budget constraining for most educational institutions and small industries as well. In this regard a pyroelectric emulator system can benefit from very low cost replacement of that test setup shown in FIG. 3 and also enables testing outside the lab without any radiation or laser application. This sort of emulator device/system enables programmability thus extending unlimited number of pyroelectric sample material properties all in one system without trial and error and enormous waste of time and initiated costs.

Pyroelectric harvesters work by converting a time-dependent temperature variation into electric current. A pyroelectric materials based energy harvesting technique is shown in FIG. 4. Pyroelectric materials can be used as the power source for many applications including bio-medical, but not limited to that.

While all of the aforementioned approaches may fulfill their unique purposes, none of them fulfill the need for a practical and effective means for a programmable portable emulator device for sensing and harvesting materials for cyclic heat energy.

The present invention therefore proposes novel devices and methods for a programmable portable emulator device for sensing and harvesting materials for cyclic heat energy.

### BRIEF SUMMARY OF THE INVENTION

The present invention, therefore, provides for devices and methods for a programmable portable emulator device for sensing and harvesting materials for cyclic heat energy.

Considering the existing and futuristic potential applications of pyroelectric materials and the high costs and complicacy involved in setting up a testing platform the concept of the analogue emulator system was derived and implemented successfully. The analogue system is now advanced to smarter, programmable, low power usage and fully digital emulator system which has eradicated many constraints and added more flexibility compare to the emulator system. The details and comparisons of these systems are presented in the following sections describing the implementation steps undertaken to convert the analogue system into a fully software driven digital device/system. The digital emulator system is devised retaining all the attributes of the analogue system and adding more advantageous features while converting into a fully digital emulator system. Thus the digital emulator system is more advanced ensuring more reliable result and thus assuring more realistic information regarding material behaviour under particular condition. The digital emulator system is equipped with augmented user friendliness, greater range of operation, operational flexibility and low power usage.

The concept of the analogue system was based on the objective to bring about a manually controlled output signal resembling that of a pyroelectric material under a particular condition. The equivalent circuit is designed with combination of resistor and capacitor commonly called as RC circuit with electromagnetic relays and provision of manual control [5]. The implemented equivalent emulator circuit is shown below in FIG. 5.

The operation of the circuit is based on the charging and discharging of the capacitor at a manually set frequency. The two relays are allowing charging and discharging of the capacitors through variable resistors R_L and R_T respectively. Triggers used to control the switching of the circuit and are inversely related with each other which can be represent by the below mentioned relationship in FIG. 6.

When Trigger 1 is switched ON the inverse of it which is OFF gets passed as Trigger 2 and vice versa thus they are never simultaneously triggered. This switching causes charging and discharging at a definite frequency depending on the time constant more commonly known as RC time constant of a RC circuit. The two diodes across the relays are serving to attain instantaneous response by rapid discharging of charges in the relay coils. The RC time constant is given by the simple formula τ=RC. The switching operations of the triggers can be represented by the switching and its inverse as shown in FIG. 7.

The simulation of the equivalent circuit was carried out varying all the parameters and component values of the designed circuit ensuring the output waveform resembles that of a pyroelectric material under the set condition. Every time the simulation results such as the peak voltage, time period, charging and discharging times were recorded and analysed for fine tuning of the circuit assuring that the output signal and corresponding values are reliable. A simulation result is shown in FIG. 8. The simulated output signal has VPYRO=0.9V at peak value at a frequency of 3 Hz for a certain RC combination as shown in FIG. 8.

The complete setup of the analogue emulator system is shown in FIG. 9 comprising of emulator module powered from wall outlet with analogue knobs and running a wrist watch by equivalent harvested energy from the pyroelectric material under a particular condition. The output signal waveform is shown in FIG. 10 and can be seen to resemble that of pyroelectric materials as per simulated and expected from the designed circuit proving functionality of the analogue circuit. The readings obtained from the emulator module which is VPYRO=1.2V at peak value at a frequency of 2 Hz in this case are recorded every time along with the corresponding RC combination selected by manual selection control of the emulator system.

In summary, the present invention generally relates to devices and methods for emulators. More specifically, the present invention relates to devices and methods comprising digital modules integrated to function as an emulator device/system utilizing program coding to operate mathematical formulation acting as a sensor and energy harvesting device.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a Heckman diagram;

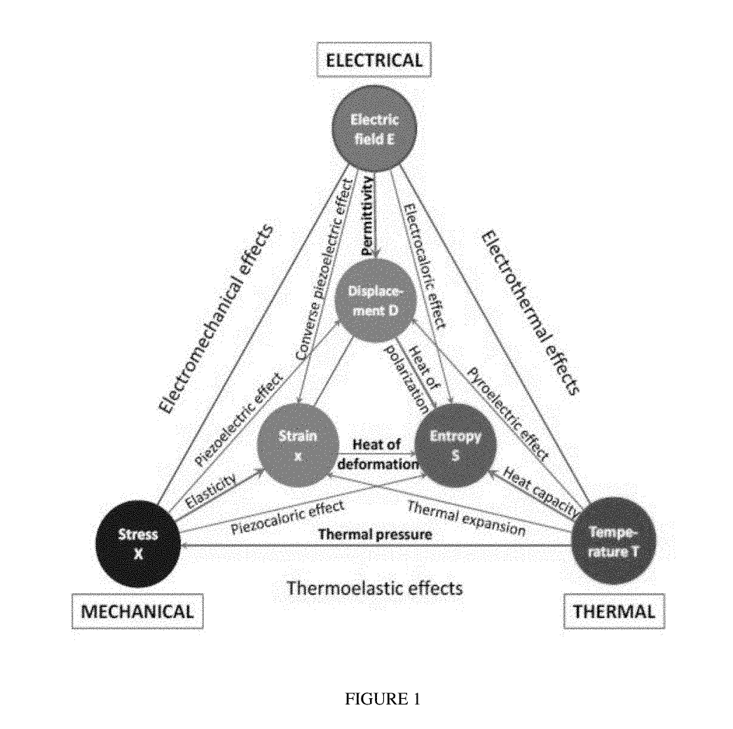

FIG. 2 is a flow chart of pyroelectric effect;

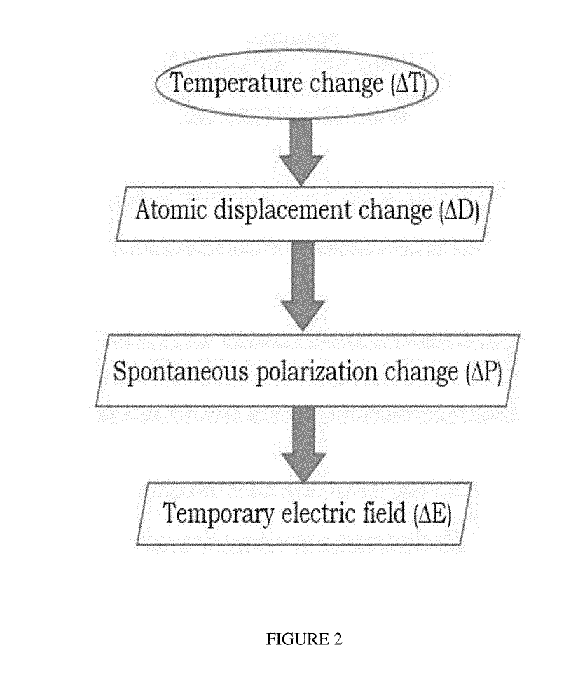

FIG. 3 is a pyroelectric test setup (liquid nitrogen cooling not shown) instruments;

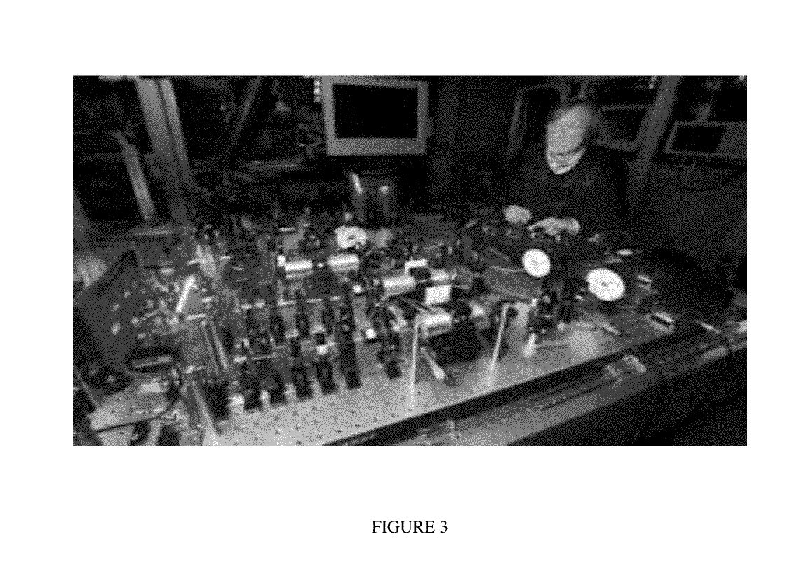

FIG. 4 illustrates energy harvesting from pyroelectric material;

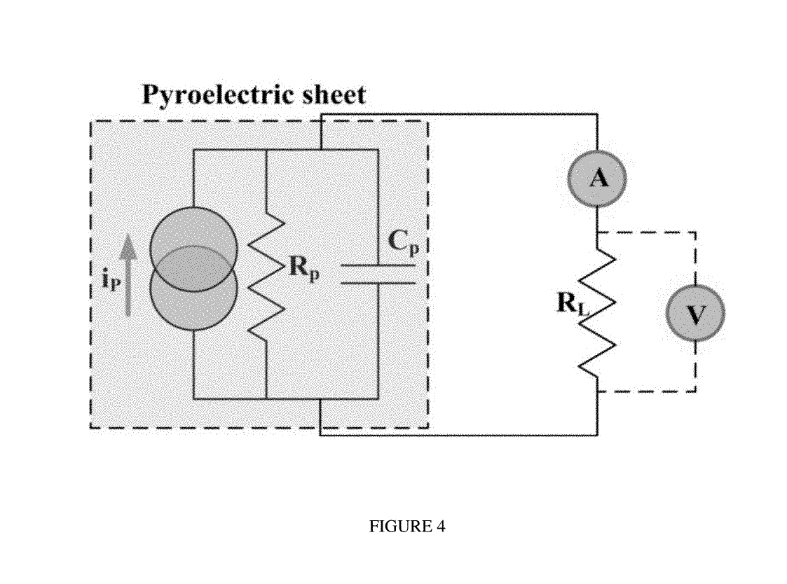

FIG. 5 illustrates an equivalent analogue emulator circuit;

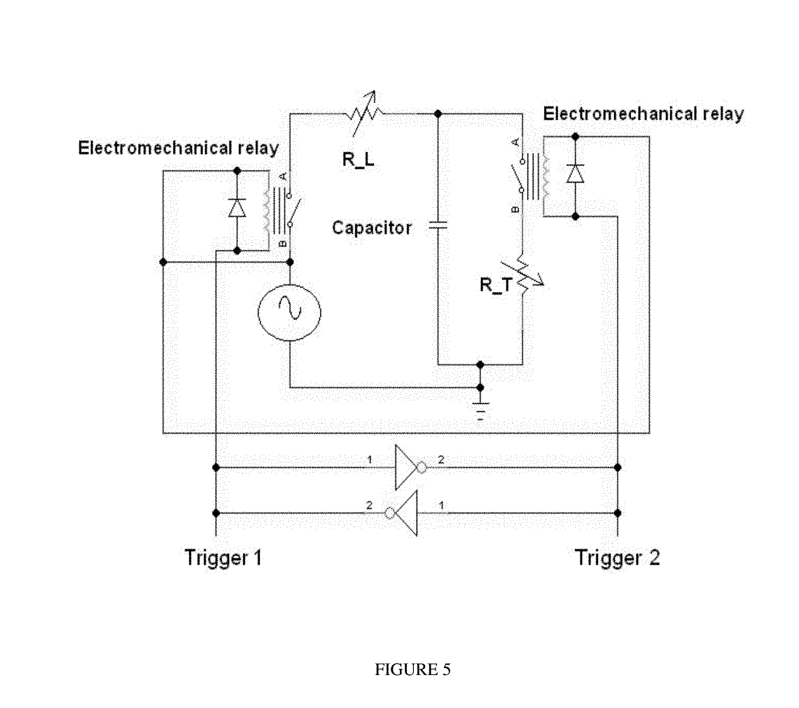

FIG. 6 illustrates the trigger logic of analogue emulator circuit;

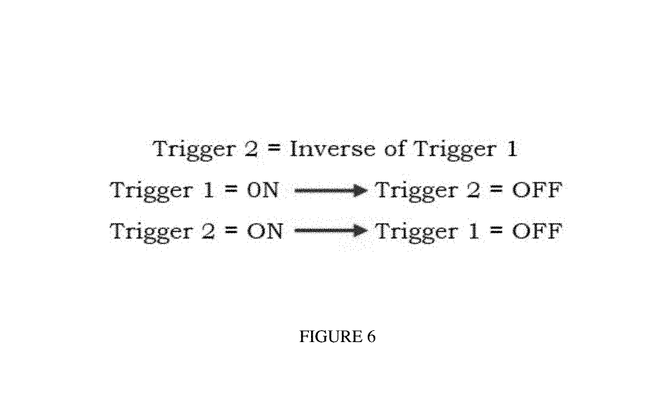

FIG. 7 illustrates the triggering signal for the analogue emulator equivalent circuit;

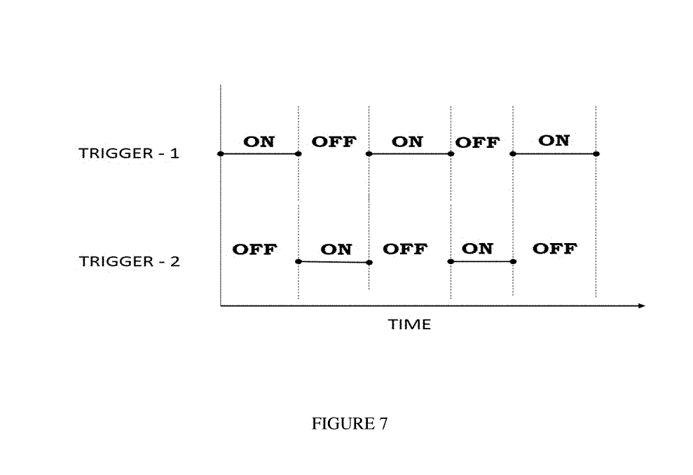

FIG. 8 illustrates the simulation output of equivalent circuit of the analogue emulator system;

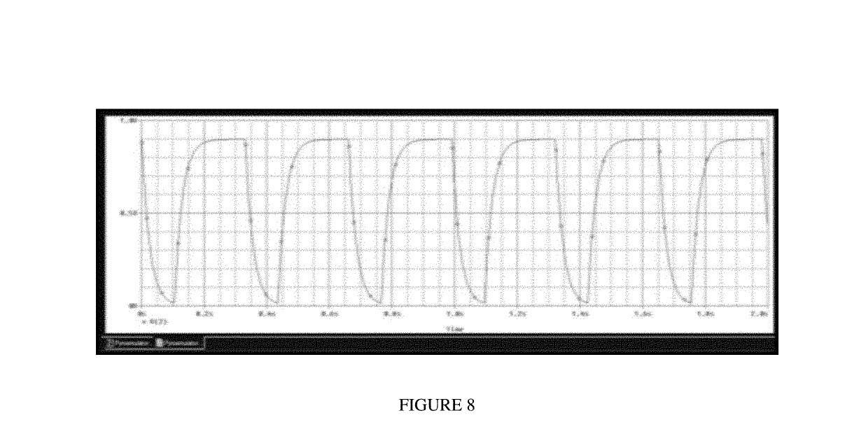

FIG. 9 illustrates the analogue emulator system setup;

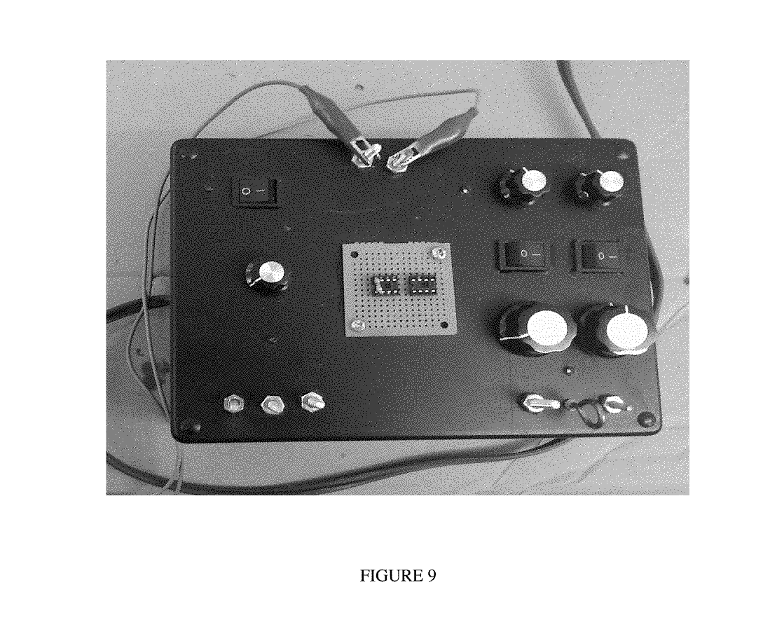

FIG. 10 illustrates the signal of the analogue emulator;

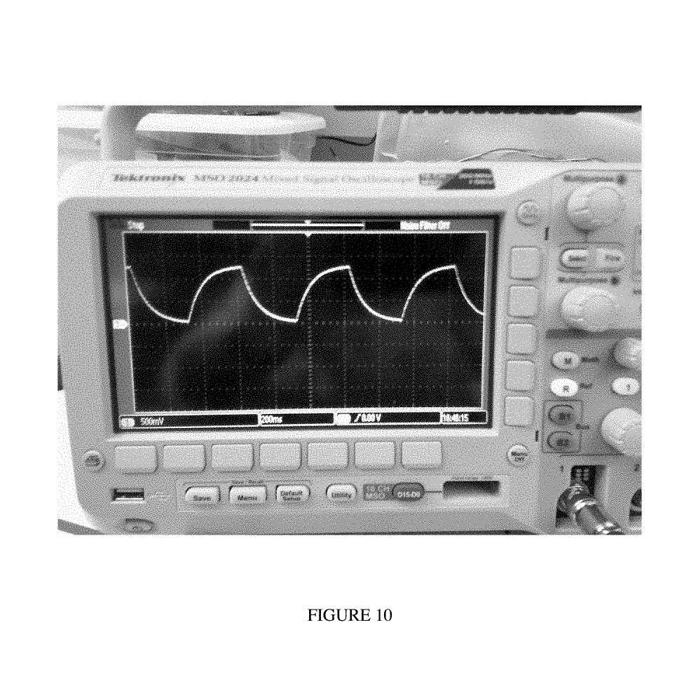

FIG. 11 illustrates the pyroelectric equivalent circuit along with adjustable loading circuit;

FIG. 12 illustrates the simulation result of the digital emulator equivalent circuit;

FIG. 13 illustrates the program codes for the ATMMega328P based microcontroller;

FIG. 14 illustrates the Tri-state truth table and gate design;

FIG. 15 illustrates the clock and clock signal for digital;

FIG. 16 is a flow diagram of the system process;

FIG. 17 illustrates a setup configuration of the device in accordance with embodiments of the disclosure;

FIG. 18 illustrates an equivalent emulator circuitry setup;

FIG. 19 illustrates a packages emulator with battery bank;

FIG. 20 illustrates a setup configuration of the device or packaged emulator in accordance with embodiments of the disclosure;

FIG. 21 illustrates an output waveform at lower loading;

FIG. 22 illustrates and output waveform at higher loading;

FIG. 23 is a flow chart of the pyroelectric emulation system; and

FIG. 24 is a setup configuration of the device or software based digital emulator system in accordance with embodiments of the present disclosure.

### DETAILED DESCRIPTION OF THE INVENTION

Disclosed herein are devices and methods for emulators. The numerous innovative teachings of the present invention will be described with particular reference to several embodiments (by way of example, and not of limitation).

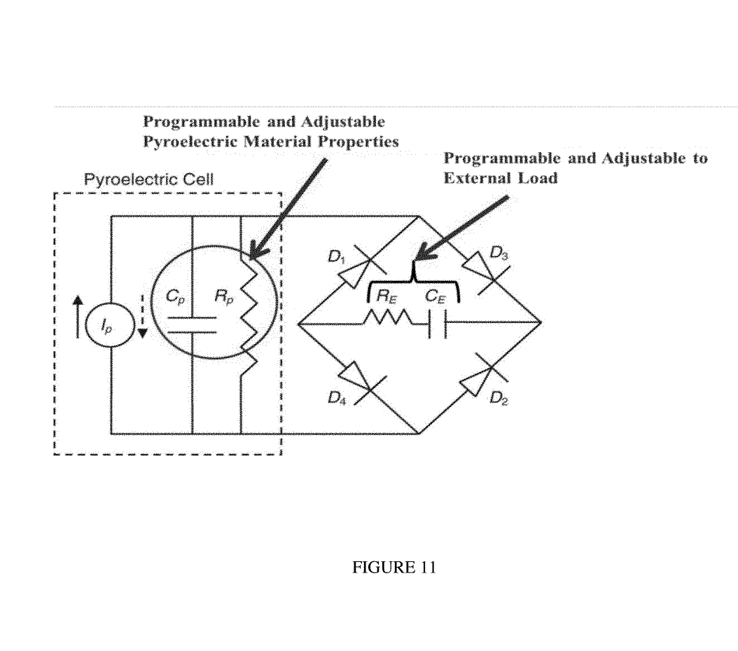

The advancement towards the software based emulator system is carried out based on the same objectives and basic concepts utilized for implementing the analogue emulator system. Taking the basic concepts and understanding further by incorporating sophisticated and advance functionality into the emulator system the software based emulator system has been designed. Digitization of the system is carried out using microcontroller based control for the driven equivalent pyroelectric circuit as shown in FIG. 11.

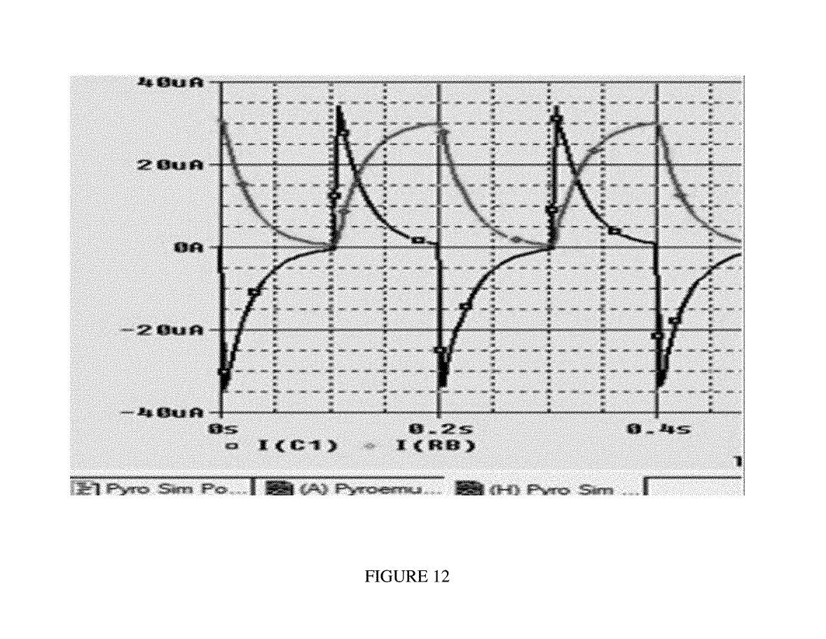

The simulation of the designed pyro equivalent circuit is conducted using advanced simulation tool and fine tuning of parameters and component values are carried out as earlier for the emulator system. The results are recorded and outputs of the simulation are compared every time after changes been made in the circuit until the signal resembles that of pyroelectric material. Both voltage and current waveform of the equivalent circuit obtained from the simulation are shown in FIG. 12. The pink line representing the output voltage VPYRO has the peak voltage of 1.3V and peak current represented by black line shows 30 μA for IPYRO with a certain RC combination. The frequency of operation is accordingly varied with RC time constant which is also recorded for each RC combination.

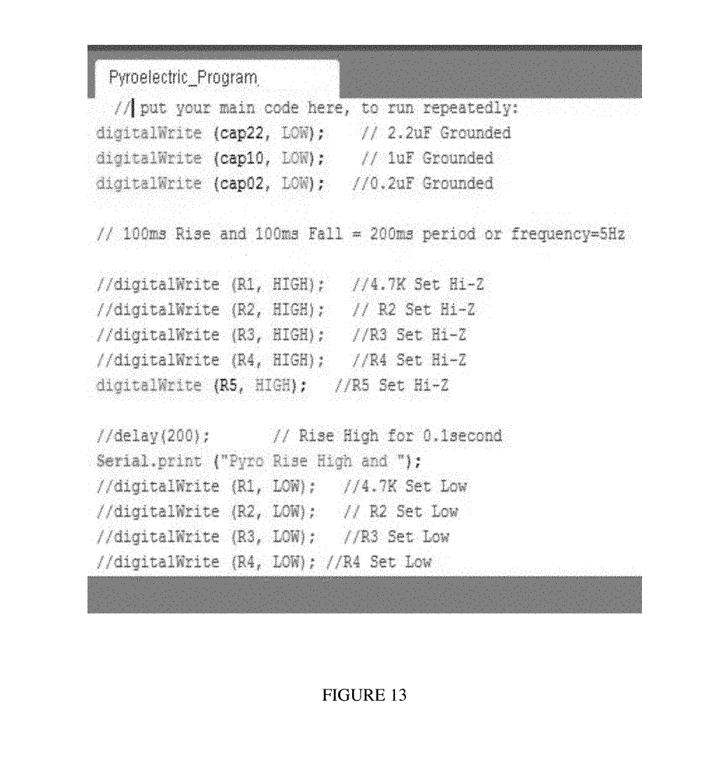

The microcontroller with a software framework is used for switching of the equivalent pyro circuit. An ATMega328P based microcontroller board (but also not limited to only this microcontroller board) has been used for this purpose and part of the program coding (but not limited to only this program coding) are shown in FIG. 13. The software framework is designed with the objective of user-friendliness, enhanced flexibility and augmented testing range in operating the emulator system. The algorithm for the program carries out sensing and component controlling of the pyro equivalent circuit and thus the component controlling becomes entirely programmable.

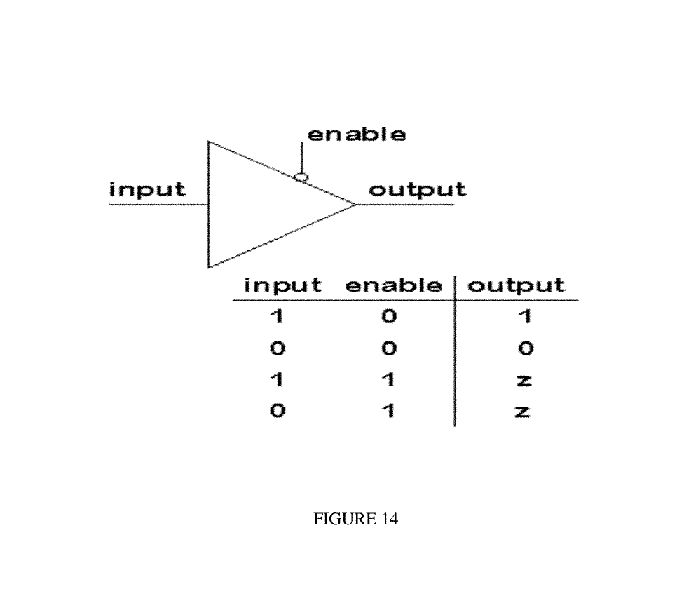

The circuit components controlling is based on the concept of Hi-Z (High Impedance) state logic and ground switching of the components connected to the IO pins of the microcontroller as per required to depict the condition for emulation. The Hi-Z and the ground switching are two of the tri-state logic in digital electronics allowing the output pins attaining states of high impedance and grounded [6]. The truth table for negative enable and an arbitrary gate of tri-state logic are shown in FIG. 14. The Hi-Z state is shown as “Z” in the truth table.

The Boolean expression for the mentioned logic gate function can be represented as shown below. When Output=Hi-Z, the output is effectively removed from the circuit thus assuring not effecting the circuit operation anyhow.

Output = Input X Enable

| | |
|---|---|
| Input = A | Enable = B |
| Boolean expression | F = A.B |
| Output = Inputat | Enable = 0 |
| Output = Hi-Z at | Enable = 1 |

As stated earlier the equivalent circuit is digitally driven from the microcontroller which is powered by USB power source from the laptop. The component controlling of the equivalent circuit being programmable exhibits increased range of conditions of emulation. The easiness achieved in component switching by allowing least parameter changes in the codes has added great flexibility to the emulator system. Simplicity of the program provides liberty to the user for carrying out various conditional emulations, and therefore, widens emulation of pyroelectric materials for various applications. The frequency of the clock and hence the timing of the switching is now entirely controlled by the microcontroller and fully programmable. Thus by varying the switching components varies the time constant of the charging and discharging of the capacitors.

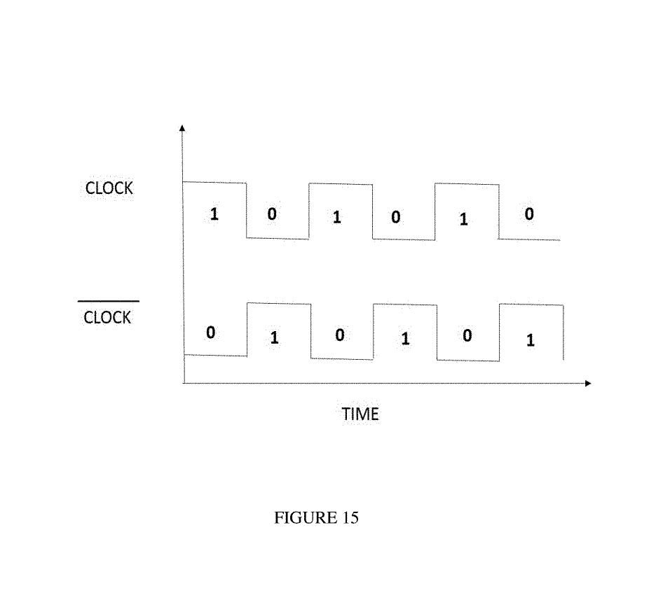

The system is devised so that digitally driven output signal resembles the analogue output signal. This is achieved by the similar concept of capacitors charging and discharging through resistors where capacitors and resistors are no more manually selected rather programmable assuring more accuracy and hence more reliability of the output signal values. The clock signal used for the digital emulator system is shown in FIG. 15 and can be represented by the simple expression given below using a NOT logic gate.

C̅L̅O̅C̅K̅=not(CLOCK)

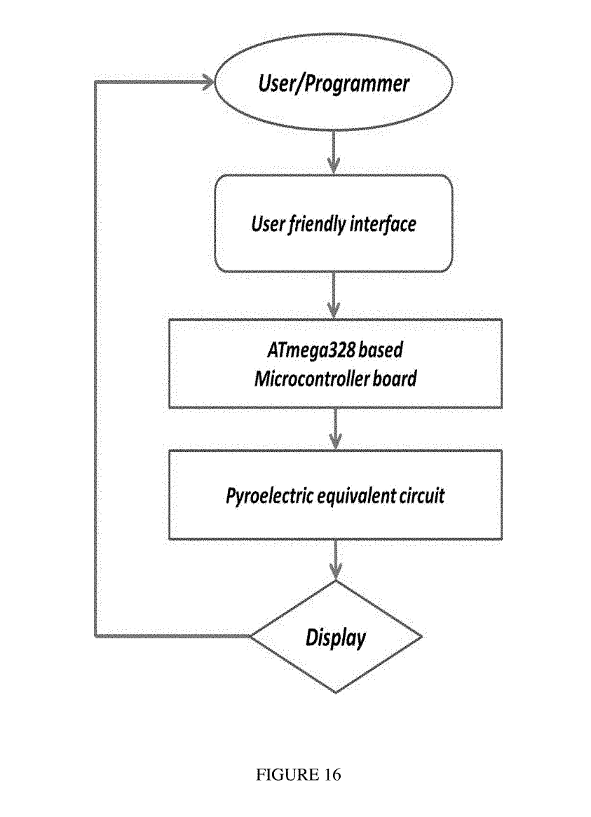

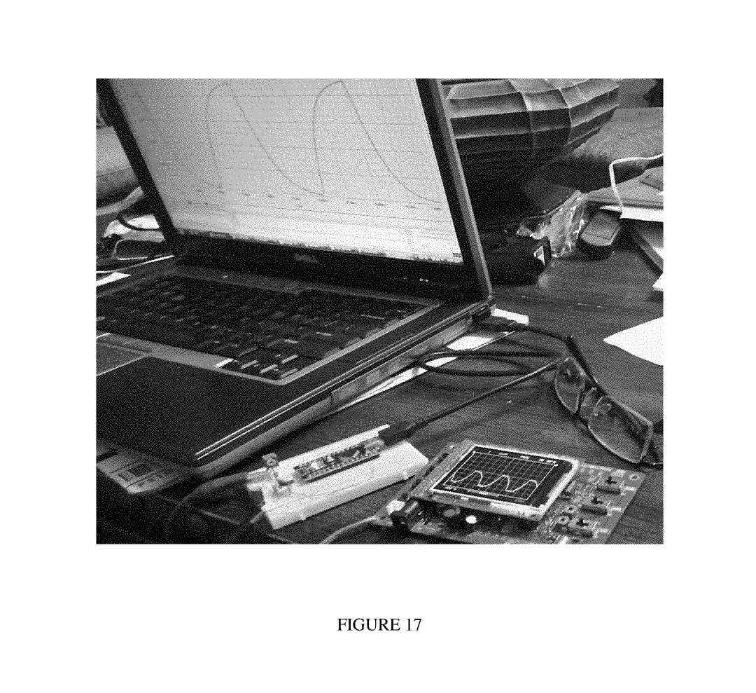

In an embodiment, the device/system is developed utilizing all the concepts so far considered and the equivalent circuit is then made to be driven by the software framework. The system is based on the step by step functioning of the user commands, software platform functioning and the corresponding component switching of the equivalent circuit. These steps are summarized in the flow chart shown in FIG. 16 below. The successful first-pass system under test based on the flow chart is shown in FIG. 17. The first-pass system was powered by standard USB port and the display is powered from AC supply of 9 VDC. The display shows the output signal that resembles that of pyroelectric materials and thus proving the functionality of the program and the equivalent circuit. This success has been taken further to develop the complete packed software based digital emulator system.

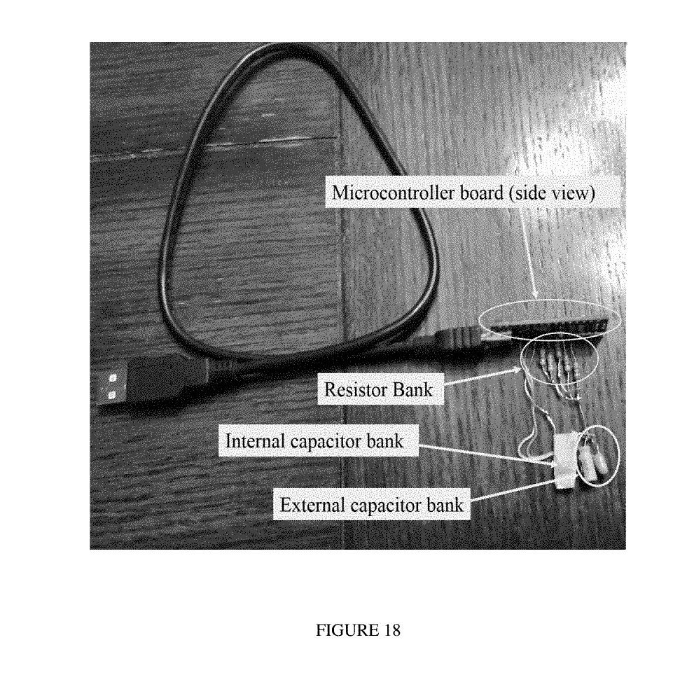

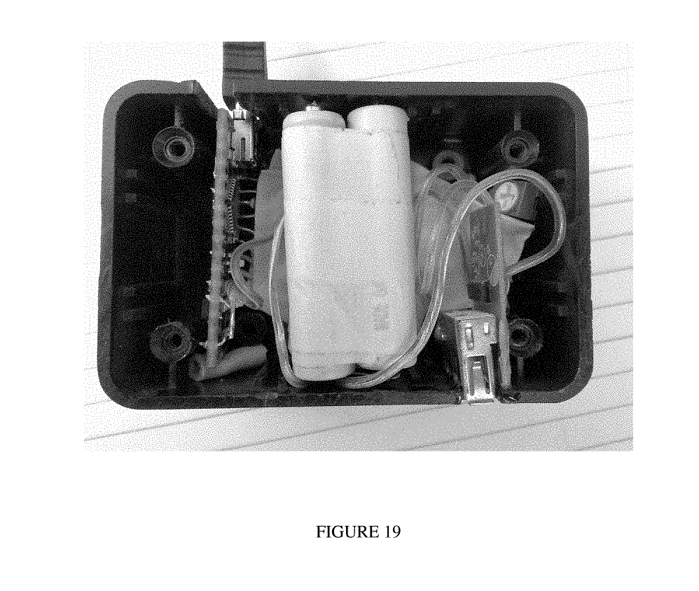

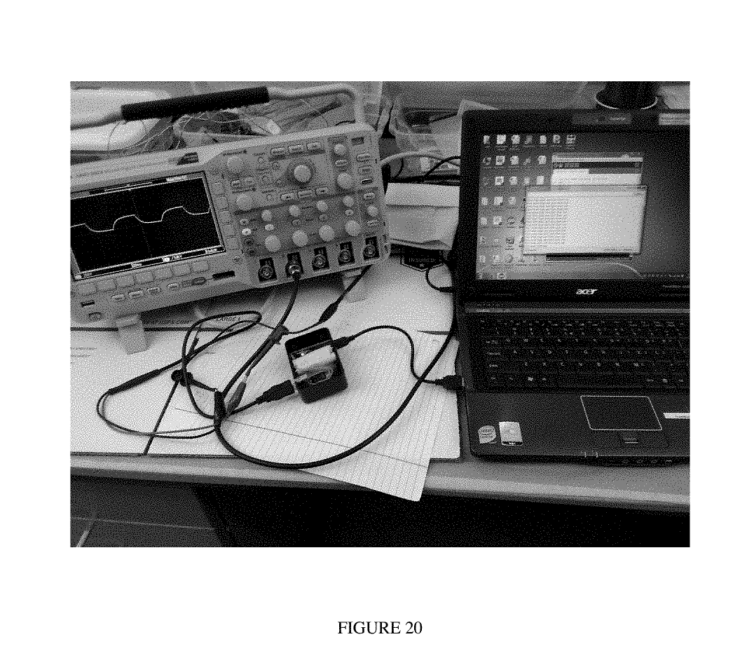

In this embodiment, the device/system lacked the rechargeable feature which is included in the packaging of the microcontroller along with the equivalent circuit. The rechargeable feature consists of a bank of lithium-ion batteries (but not limited to) to provide power for the entire software based digital emulator module. The system can also run directly from the standard USB less than average of 35 mA. The assembled RC circuitry along with the microcontroller showing capacitor bank (CB), external load capacitors for available charge and bank of resistors are shown in FIG. 18. The packaged emulator system is also shown with battery bank inserted in FIG. 19. And the packaged emulator system under test is shown in FIG. 20.

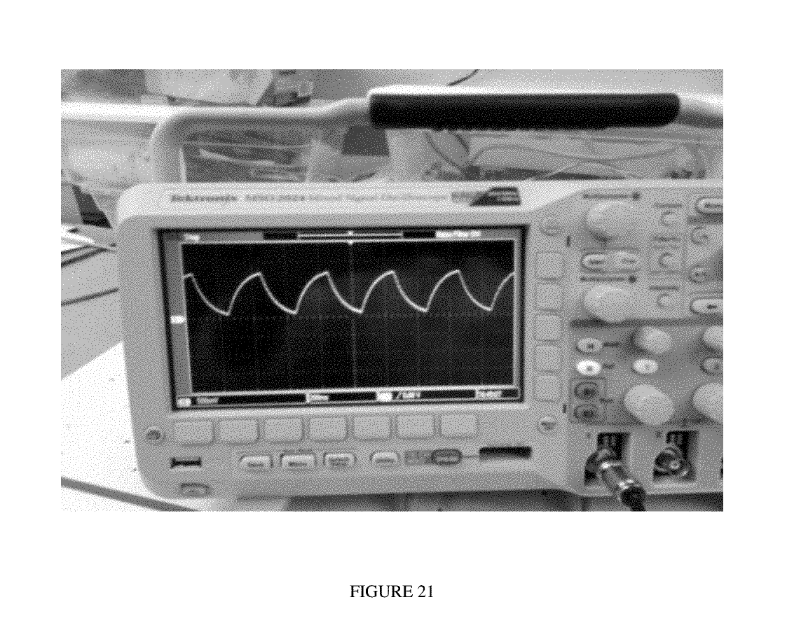

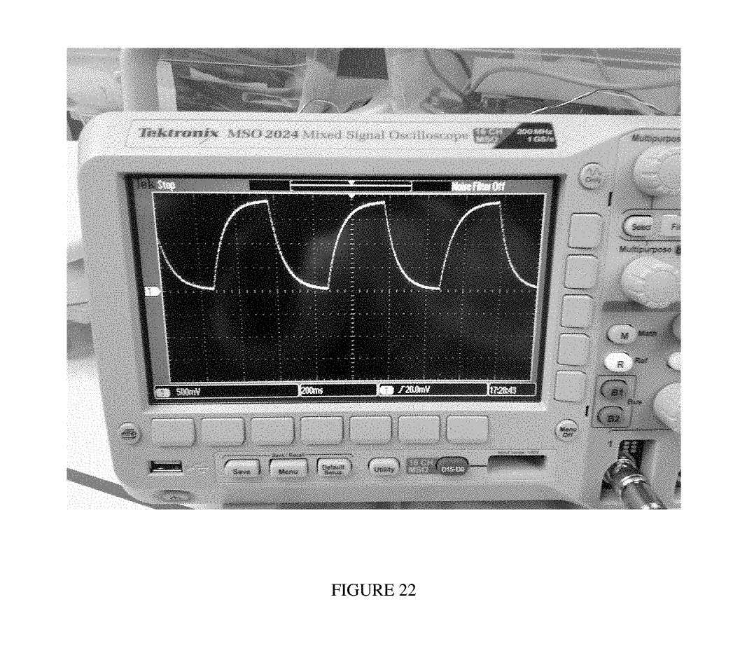

All these system development and packaging leads to the final setup for the software based digital emulator system following the much advanced flow chart and more features are also incorporated to augment the functionality. It is also successfully verified that the loading of the equivalent circuitry yields the desired pragmatic signals as shown for two loading conditions below in FIG. 21 and FIG. 22.

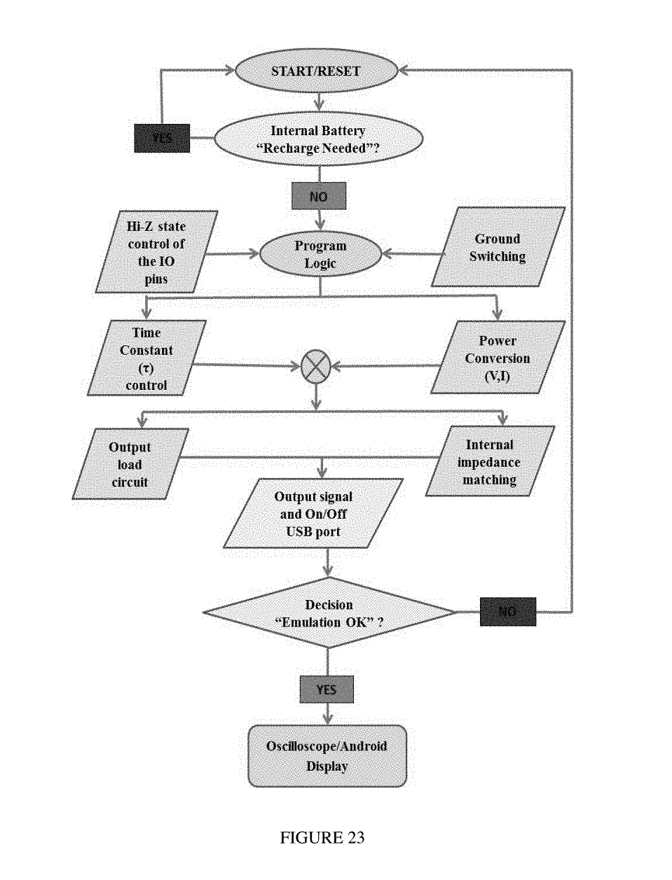

The updated flow chart of the software based digital emulator system is shown in FIG. 23 below. The flow chart of the system shows the various steps the emulation system goes through depending on different logics and condition. The program logic is based on the inputs from Hi-Z state and ground switching that decides which IO pins and in turn which capacitor and resistor will undergo state change and eventually allows conduction through them. This allows energy to be stored in the capacitor. The output load connection and the internal impedance matching are completed which leads to the output of the circuit to be displayed on the oscilloscope. The provision for recharging the batteries through the same universal serial bus (USB) as uploading program codes adds to the flexibility of the entire system. There is another provision in the system that it allows the system to switch “ON” only when the oscilloscope probe is connected to it. The sensing used to switch the system “ON” when the oscilloscope probe is connected and is the process to recharge the battery is unique in the sense that this switching process is implemented with an objective to save unnecessary power usage from the system. The design of the software framework also allowing the user to monitor all necessary data from the emulation on the computer screen exactly showing the emulation result values required to get to a detailed understanding of the behaviour of the pyroelectric material under test.

The current “I_{P}” from the pyroelectric element can be represented as shown in equation (1). The net charge “Q” developed from pyroelectric material due to temperature change of ΔT can be derived integrating the equation of current and is represented as shown in equation (2) [7-8].

$$\begin{matrix}{I}_{p} ( t ) = \frac{dq}{dt} = p A \frac{dt}{dt} & ( 1 ) \\ Q = \int ( pAdT / dt ) dt = p A Δ T & ( 2 )\end{matrix}$$

Where ‘p’ is the pyroelectric coefficient and ‘A’ is the surface area. The pyroelectric material is of dielectric in nature and hence the energy from the pyroelectric material as represented in equation (3) resembles that for the energy stored in the capacitor of the pyro equivalent circuit [9].

$${E}_{PYRO} = \frac{1}{2} \frac{{p}^{2}}{{∈}_{33}^{σ}} A {h ( Δ T )}^{2} \qquad ( 3 )$$

Thus the energy stored in capacitor gives the energy the pyro material can generate under that particular loading condition. Since, varying the resistor and the capacitor varies the energy stored and time constant, it is indispensable to infer the relation between time constant (τ) which is given by τ=RC and energy stored in the capacitor. The energy stored in the capacitor “C” charged to the voltage “V” is represented by equation (4) [8-10]. And the corresponding time constant variation is given by equation (5).

E_{CAPACITOR}=1/2Σₙ₌₁^{k}CnV(Cn)² (4)

τ=Σᵢ₌₁^{j}=RiΣₙ₌₁^{k}Cn (5)

The digitally determined time constant, τ=RC where the frequency of the signal is given by equation (6) and the binary coded decimal selections of “R” and “C” using the program coding are exemplified in the tables below.

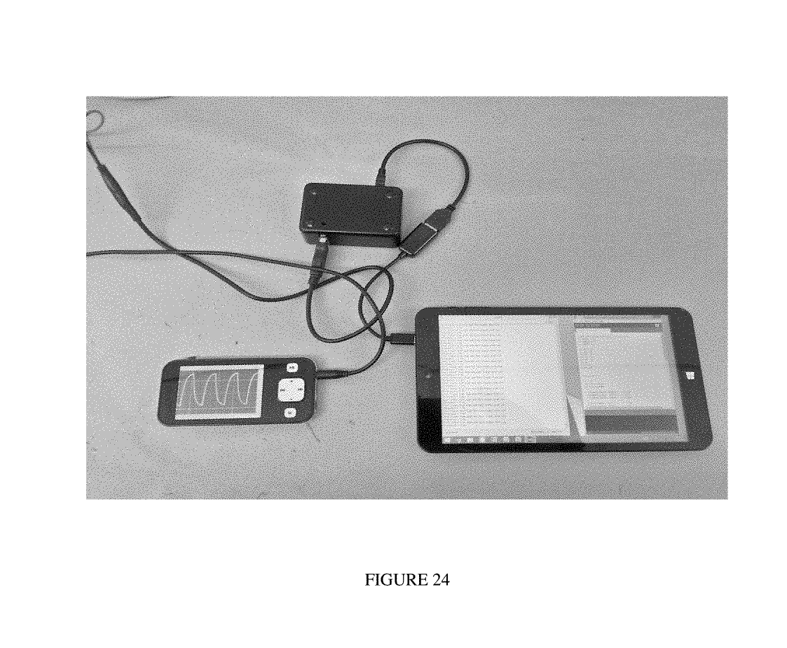

The final set up of the software based digital emulator device/system has been given the successfully implemented with proper functionality and producing desired signal. The entire system is completely portable and the complete set up of the emulator system is shown in FIG. 24 and consists of three modules that are described below.

Each module of the complete system is described below:

(A) The pocket sized emulator module with dimensions of 3″L×2″W×1″H (approx.) including RC equivalent circuits, microcontroller board and rechargeable battery bank.

(B) The pocket sized rechargeable digital oscilloscope board of 2.75″ diagonally.

(C) A dual OS tablet (optional) of 7″ diagonal screen runs the microcontroller program for monitoring the system's results.

The advancement in the emulator system in the form of software based digital emulator system will bring drastic improvements and breakthroughs in working with pyroelectric materials both as sensors and as energy harvesters as well. Thus extending the areas of applications for such materials. The digital system with all the newly equipped advancements will be pivotal in enhancing existing applications of pyroelectric materials and in cultivating futuristic applications and implementations. The power consumption of the software based emulator is half the power consumption of analogue emulator module providing far more reliability and assuring rapid and wide parametric range of emulations to be carried out. The attributes of the analogue system and the evolved software based digital system are compared in the table 3 below. And the total energy from the pyroelectric emulator system at certain program setup for few selections from hundreds of possible selections are shown in the table 4 with corresponding τ.

It is evident that the digital system has been significantly improved in many ways compare to the analogue system and meets up the expectations considered from the technological evolution from the analogue system to the software based digital system. Design is completed for commercial systems which will implement the available stored energy up to 5 milli-Joules. The system can be improved further by incorporating more advanced features and options in order to precisely emulate more pragmatic applications of materials as sensors and energy harvesters.

In brief, as described herein provides for an effective and efficient devices and methods for emulators.

The disclosed devices and methods are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed devices or methods, except as may be outlined in the claims.

Any embodiments comprising a one component or a multi-component device having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific devices and methods described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The devices and/or methods disclosed and claimed herein can be made and executed without undue experimentation in light of the present disclosure. While the devices and methods of this invention have been described in terms of preferred embodiments, it will be apparent to those skilled in the art that variations may be applied to the devices and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

### REFERENCES

1. Jani Perantie, “Electric-field-induced dielectric and caloric effects in relaxor ferroelectrics” Acta Univ. Oulu, University of Oulu, Vol. C, No. 489, 2014, pp. 17-19.
2. Relva C. Bauchanan, Ceramic Materials for Electronics. New York: Marcel Dekker, Inc., 2004, pp. 216-220.
3. Wikipedia, “Pyroelectricity” [Online]. Accessed on December 2015, Available: https://en.wikipedia.org/wiki/Pyroelectricity.
4. Frank Livingston, Alan Hopkins, and Bruce Weiller, “The next big thing: Nanomaterials Development for space technology applications” Crosslink Magazine, Vol. 12, No. 1, 2011.
5. Wikipedia, “RC Circuit” [Online]. Accessed on December 2015, Available: https://en.wikipedia.org/wiki/RC_circuit.
6. Wikipedia, “Three-state logic” [Online]. Accessed on December 2015, Available: https://en.wikipedia.org/wiki/Three-state_logic.
7. Chun-Ching Hsiao and Jia-Wai Jhang, “Pyroelectric Harvesters for Generating Cyclic Energy” Journal of Energies, Vol. 8, No. 5, 2015, pp. 1-14.
8. Jingsi Xie, “Experimental and Numerical Investigation on Pyroelectric Energy Scavenging” [Online]. Accessed on December 2015, Available: http://scholarscompass.vcu.edu/cgi/viewcontent.cgi?article=3040&context=etd
9. Wikipedia, “Capacitor” [Online]. Accessed on December 2015, Available: https://en.wikipedia.org/wiki/Capacitor.
10. Titus Sandu, George Boldeiu and Victor Moagar-Poladian, “Applications of Electrostatic Capacitance and Charging”, Journal of Applied Physics, Vol. 114, No. 224904, 2013, http://dx.doi.org/10.1063/1.4847495 [Online].
11. Sidney B. Lang, Sourcebook of Pyroelectricity. New York: Gordon and Breach Science Publishers, 1974, pp. 2-4.

What is claimed is:

1. A programmable emulator for sensing and harvesting materials for cyclic heat energy as disclosed herein.

2. Methods for a programmable emulator for sensing and harvesting materials for cyclic heat energy as disclosed herein.

3. A device that contains digital modules that are integrated to function as an emulator device, implying program coding for electronic microcontroller to operate by inclusion of mathematical formulation for pyroelectric devices.

4. The device of claim 1, wherein the pocket digital module optimized at low power <40 mA, but not limited to this current value.

5. The device of claim 1, wherein the portability of the device consisting of a pocket digital pyro module, pocket oscilloscope module, portable pocket computer tablet module with dual operating system, but not limited to.

6. The device of claim 1, wherein each component of the device is rechargeable with lithium based batteries, but not limited to.

7. The device of claim 1, wherein the device turns on or wakes up automatically by the signal output cable when connected.

8. The device of claim 1, wherein the device is fully programmable for pyroelectric emulation from 2 Hz to 300 Hz, but not limited to only these frequencies.

9. The device of claim 1, wherein the load conditions are adjustable between 0.160 to 2000, but not limited to these values.

10. The device of claim 1, wherein the signal output cable is standard USB connectivity, but not limited to, with auto turn on configuration.

11. The device of claim 1, wherein the entire device has micro USB charging connectivity, but not limited to only this.

12. The device of claim 1, wherein signal peak can be changed by RC parametric hardware setup for voltage reference of the signal.

13. The device of claim 1, wherein the device is capable to run without the portable tablet, yet required to view the system operational monitoring purposes, but not limited to only tablet devices.

14. The device of claim 1, wherein the Hi-Z function of the pyro module is embedded in the microcontroller's flash memory by the dedicated custom program codes, but not limited to only this process.

15. The device of claim 1, wherein dedicated pyroelectric control algorithms are created and applied by the program subroutines codes for proper execution, but not limited to this technique.

16. The device of claim 1, wherein emulated pyroelectric energy available at the output of the device is always safe to deliver without affecting the circuit and thus making it short-circuit protected.

17. The device of claim 1, wherein the device is recharging from any 5V USB sources, but not limited to that; such as computer USB port.

18. The device of claim 1, wherein the device can emulate a pyroelectric sensor as well as energy harvesters, but not limited to these.
